(19) United States
(12) Patent Application Publication
(10) Pub. No.: US 2015/0135797 A1
(43) Pub. Date: May 21, 2015

(54) DEVICE AND METHOD FOR MULTIPHASE FLOW METER CALIBRATION USING A CLOSED LOOP MULTIPHASE FLOW SYSTEM

(71) Applicants: YPF Tecnologia S.A., Ciudad de Buenos Aires (AR); Spinlock SRL, Cordoba (AR)

(72) Inventors: Reynaldo Martín ROMERO, Buenos Aires (AR); Gustavo Damian GARBATI, Buenos Aires (AR); Carlos Alberto LAGO, Buenos Aires (AR); Amadeo SASIA, Cordoba (AR); Bernardo BALLESTÉ, Cordoba (AR); Julia GARCIA, Cordoba (AR); Sebastian MORE, Cordoba (AR); Daniel PUSIOL, Cordoba (AR); Dante PUSIOL, Cordoba (AR)

(21) Appl. No.: 14/548,889

(22) Filed: Nov. 20, 2014

Related U.S. Application Data
(60) Provisional application No. 61/906,679, filed on Nov. 20, 2013.

(51) Int. Cl. G01F 25/00; G01F 1/74

(52) U.S. Cl. CPC G01F 25/0007; G01F 1/74
USPC 73/1.16

(57) ABSTRACT

Calibration of a multiphase flow meter to be used in a production process can be achieved by using a closed multiphase flow loop. In the device and method of the invention, the flow rates of each phase, oil and water, are individually measured after their separation using a separation vessel, and used as a reference for the calibration of a multiphase flow meter. Flow loop control is achieved by combining an oil-water interface position control and an oil level control in the separation vessel.

### FIELD OF THE INVENTION

This invention relates to a device and method for the calibration of a multiphase flow meter by means of a closed loop multiphase flow system.

### BACKGROUND OF THE INVENTION

Multiphase fluid flow is defined as the simultaneous flow of materials having different phases, wherein the term “phase” refers to thermodynamic systems throughout which all physical properties of a given material are essentially uniform. This definition includes the case of the simultaneous flow of materials with different sates of aggregation (e.g. solid, liquid and gaseous) as well as the flow of two or more thermodynamically incompatible phases with the same state of aggregation (e.g. an aqueous phase and an organic phase), or a combination of both cases. The term “aqueous phase” as used herein, refers to a phase consisting of water or an aqueous solution, the term “organic phase” refers to a phase which is essentially immiscible with an aqueous phase, such as oil, organic solvents, etc.

This type of fluid flow can also be encountered in many types of industrial processes, such as riser reactors, bubble bed column reactors, fluidized bed reactors, dryers, etc.

In particular, multiphase flows are frequently encountered in the production of oil and gas, as the well-produced fluid often consists of mixtures of oil, water and gas.

The study of multiphase flow is a challenging area of fluid mechanics, because both the thermodynamic and non-equilibrium behaviors of multiphase systems are not easily described by mathematical models. Furthermore, as opposed to the case of a single-phase fluid flow, a great variety of flow regimes is found in the case of multiphase flow, due to the effects of fluid properties such as surface tension, compressibility, etc. and the interactions effects of a multiphase system. The study of multiphase flow systems is strongly dependent on adequate measurement techniques, as there is limited availability of comprehensive models that are able to fully describe the multiphase system and its characteristics.

In the particular case of an oil production process, the adequate measuring and characterization of a multiphase well-produced fluid flow is directly related to the production process productivity and may determine the downstream processes design and operation. The adequate measurement can also facilitate reservoir management, field development, operational control, flow assurance as well as production allocation.

The conventional techniques used in the measuring of multiphase flows in the petroleum industry often rely on a good phase separation and an individual measuring technique for each phase. This requires the use of expensive and often large multiphase test separation vessels, high maintenance, and field personnel intervention. In addition, these conventional techniques do not lend themselves to continuous monitoring or metering of the produced fluid. The current trend in multi-phase flow metering is to provide a viable alternative to the use of these separation vessels. Such alternative might be obtained by using a multiphase flow meter.

As used herein, the term “multiphase flow meter” (MPFM) refers to a device used to measure the flow rates of a given multiphase flow.

The use of MPFM in an oil production process precludes the use of the expensive multiphase separation vessel used in the conventional measuring techniques, which has an economic impact that can be substantial in the case of marginally economical reservoirs.

There is a great variability in the multiphase characteristics of a well-produced fluid, imposed by the well unique geological characteristics. As is the case with any measuring device, a proper calibration of the MPFM is therefore needed when using it in a production process.

There is therefore a need to provide adequate and reliable calibration techniques for a multiphase flow meter to be used in the measurement of the multiphase flow variables of an oil production process.

### BRIEF DESCRIPTION OF THE INVENTION

An adequate calibration of a MPFM to be used in an oil production process can be achieved by means of a closed multiphase system, hereinafter referred to as “multiphase flow loop”. The material flows of said flow loop comprise an aqueous phase and an organic phase as previously defined (hereafter respectively referred to as “water phase” and “oil phase”) and a gaseous phase. The MPFM is to be calibrated by calculating “correction factors” which relate the measurements by a single MPFM for the multiphase stream, to the individual measurements made by measuring devices in each of the separated phases.

It is therefore an object of the present invention to provide a device for calibration of a MPFM, comprising:
a separation vessel for separating oil, gas and water phases, comprising a first compartment for containing the oil-and-water mixture to be separated, a second compartment for containing the oil phase already separated, and a gas chamber common to both of said compartments,
an oil pipeline comprising feeding means for providing oil to said second compartment from a stock oil tank,
a water pipeline comprising feeding means for providing water to said first compartment from a stock water tank,
a gas pipeline comprising feeding means for providing gas from a stock gas tank,
an oil pipeline comprising outlet means for producing an oil stream out of said separation vessel and setting and metering means for metering said oil stream flow rate, a water pipeline comprising outlet means for producing a water stream out of said separation vessel and setting and metering means for metering said water stream flow rate,
a gas pipeline comprising outlet means for producing a gas stream out of said separation vessel and setting and metering means for metering said gas stream flow rate,
a collecting pipeline for collecting said oil, gas and water streams into one oil, gas and water stream and feeding means for feeding back the oil, gas and water stream into the separation vessel,
a multiphase flow meter to be calibrated connected to said oil, gas and water stream, producing flow rate measurement data,
a calibrating system for processing measurement data from the oil stream, the gas stream and the water stream, and the oil, gas and water stream flow meters and obtaining a corresponding correction factor for the multiphase flow meter to be calibrated.

The separation vessel further comprises control means for controlling the oil-water interface level in said first compartment within a predetermined range and control means for controlling the oil level in said second compartment within a predetermined range.

During operation of the device and method of the present invention, the water, oil and gaseous phase streams circulating in the multiphase flow loop are individually measured and monitored prior to their mixing and stabilization before entering the MPFM. After the measurement by the MPFM, the individual phases are recycled to the separation vessel.

It is another object of the present invention to provide a method for calibrating a MPFM, said method comprising:

separating an oil phase, a gas phase and a water phase from a three-phase mixture consisting of a two-liquid oil-and-water phase and a gas phase, in a separation vessel comprising a first compartment for the three-phase mixture and a second compartment for the separated oil and gas phases, producing a water stream from the first compartment, and an oil stream and a gas stream from the second compartment,
setting, measuring and keeping the oil stream flow rate at a predetermined value, setting, measuring and keeping the water stream flow rate at a predetermined value,
setting, measuring and keeping the gas stream flow rate, at a predetermined value,
combining the oil stream with the water stream in a two-phase oil-and-water stream,
combining the two-phase oil-and-water stream with the gas stream in one three-phase stream containing oil, gas and water,
measuring said three-phase stream flow rate by means of a multiphase flow meter to be calibrated,
recycling the three-phase stream to the first compartment of the separation vessel,
processing the obtained three-phase stream flow rate data along with the predetermined oil stream, gas stream and water stream values so as to produce a correction factor.

The method further comprises controlling and keeping the two-liquid oil-and-water phase level in the first vessel compartment within a predetermined range by addition or draining of water from or to a water stock tank, and controlling and keeping the oil phase in the second vessel compartment within a predetermined range by addition or draining of oil from or to an oil stock tank.

In a preferred embodiment of the device of the present invention, the oil-water interface position control means comprises a sensor probe control means and a transmitter.

In another preferred embodiment of the device of the present invention, the oil-water interface position control means comprises an Agar Solutions® ID-200 Series Interface Concentration Detector System.

In yet another preferred embodiment of the device of the present invention, the oil level control means comprises a level controller selected from the group comprising a radar level transmitter, a guided wave radar level transmitter and an ultrasonic level transmitter.

In preferred embodiments of the invention and according to process requirements, the “water stock tank” may further comprise a separate brine stock tank with all necessary ancillary equipment, like pumps and pipelines.

### BRIEF DESCRIPTION OF THE DRAWINGS

FIG. 1 shows a flow sheet diagram and the calibration device of the present invention.

FIG. 2 shows the flow sheet and the calibration device of FIG. 1, further comprising a second water stock tank, e.g. for containing brine.

### DETAILED DESCRIPTION OF THE INVENTION

The invention will be described in detail below with reference to the figures.

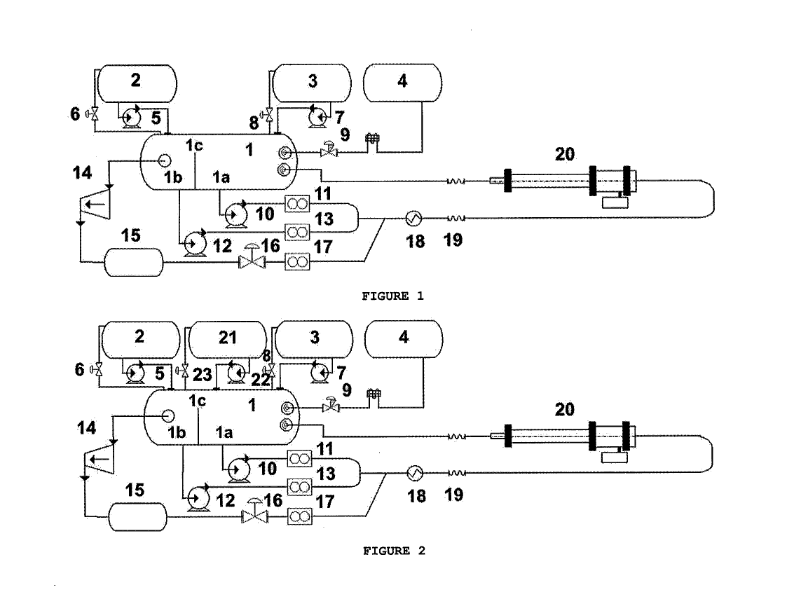

A schematic representation of a preferred embodiment of the device of the present invention, comprising a multiphase flow loop system, is presented in FIG. 1. In FIG. 2, a similar multiphase flow loop is presented, in which a second stock water tank is included, e.g. for containing brine. The need for this second tank and all its associated ancillary equipment (i.e. pumps, pipelines and valves) will depend on the characteristics of the fluid for which the MPFM is to be calibrated.

The device comprises a separation vessel 1 consisting of two compartments 1a and 1b, separated and defined by a separating wall or baffle 1c. During normal operation of the calibration method, the first compartment 1a contains a mixture of oil and water and the second compartment 1b contains separated oil. A common chamber above compartments 1a and 1b contains the gas phase.

The operation of the calibration method is divided into two separate sections: “Start-up operation” and “Normal operation”. The start-up operation section comprises the filling of the empty separation vessel with the fluids to be used in the multiphase flow loop. The normal operation section refers to the calibration procedure once the separation vessel is filled and a stable operating regime has been achieved.

### Start-Up Operation

This section comprises the filling of a multiphase separation vessel with the fluids to be used in the multiphase flow loop system. The separation vessel is initially empty and unpressurized.

The first compartment of the separation vessel is filled with water provided from a water stock tank 2, by means of a water injection pump 5, and/or by brine from a brine stock tank 21 by means of a pump 22. The liquid level inside the separation vessel 1 is controlled by means of an electronic level transmitter (not shown). Once the liquid level reaches a preset value the level transmitter acts on the water injection pump 5, in order to prevent further filling of the separation vessel.

In the embodiment of FIG. 2, according to the type of calibration needed for the particular oil production system, said level transmitter may act on the freshwater pump 5 or on the brine pump 22, if necessary.

Once the separation vessel first compartment 1a is filled with water, the second compartment 1b is to be filled with oil.

The filling of the second compartment 1b is carried out by an oil injection pump 7 which pumps the oil from an oil stock tank 3. The oil is introduced into the separation vessel 1 until the oil level is greater than the height of the separating baffle 1c, in order to ensure that the oil spills or flows over the baffle into the first compartment 1a.

The liquid level inside the second compartment 1b of the separation vessel 1 is controlled by an electronic level transmitter (not shown). Once the liquid level in both compartments are equalized and the liquid level in the second compartment reaches a preset value, the level transmitter acts on the oil injection pump 7 in order to prevent further filling of the separation vessel 1.

The separation vessel 1 is then pressurized in accordance with the operating conditions for MPFM calibration. The operating pressure will be preset for each particular calibration and regulated by means of a pressure control valve 9 connected to a gas stock tank 4. Once the pressure inside the separation vessel 1 is established, the oil level in the second compartment 1b is brought to its normal operation value by draining the oil compartment by means of a level transmitter acting on a control valve 8 in the oil draining line. This draining line is fed to the oil stock tank 3.

Once the oil level corresponds to its normal operation value, the multiphase flow loop system can be taken to its normal operation mode, as subsequently described.

### Normal Operation

This section comprises the normal operation of the device of the present invention, comprising a multiphase flow loop system, for the calibration of a MPFM.

Both the oil/water interface position control and the oil level control are key aspects in the regulation of the flow loop system in its integrity during the normal operation of the flow loop system according to the present invention. Nonetheless, both controls will have no direct action on the equipment applied to the measuring process, like each separated phase flow meter, or the MPMF itself, which constitutes an advantageous operational mode for the flow loop system.

The oil-water interface position in the first compartment 1a of the separation vessel 1 is set to vary in a preset range. The position of the interface is sensed by an adequate sensor device, like an Agar Solutions® ID-200 Series Interface Concentration Detector System. It should be noted that the interface between the two immiscible liquids forms an emulsion. The position of the interface inside the separation vessel 1 depends on the ratio between water and oil, which can vary according to the water-cut of the well-produced fluid. However, the changes in the position of the oil-water interface should be minimal during the steady operation of the flow loop system. In this case, the position of the interface remains within a preset position range, called “control band”.

If—by process requirements—the interface position is lower than the control band, the interface control acts on the pump 5 associated to the water stock tank 2 or on the pump 22 associated to the brine stock tank 21. The pump will drive water into the first compartment 1a of the separation vessel 1, raising the interface position to reach a value within the control band.

Similarly, if—by process requirements—the interface position is greater than the control band, the interface control acts on a control valve 6 associated to the water stock tank 2 or on a control valve 23 associated to the brine stock tank 21. Water or brine are then drained from the first compartment 1a of the separation vessel, lowering the interface position to reach a value within the control band.

The oil level in the second compartment 1b of the separation vessel 1 is set to vary in a preset range. The level is sensed by an adequate sensor device, like a radar level transmitter, a guided wave radar level transmitter and an ultrasonic level transmitter. The oil level in the second compartment 1b of the separation vessel 1 depends on the quantity of oil, which can vary according to the water-cut of the well-produced fluid. However, the changes in oil level should be minimal during the steady operation of the flow loop system. In this case, the level remains within a control band.

If—by process requirements—the oil level is lower than the control band, the oil level control acts on the pump 7 associated to the oil stock tank 3. The pump will drive oil into the second compartment 1b of the separation vessel 1, raising the oil level to reach a value within the control band.

Similarly, if—by process requirements—the oil level is greater than the control band, the oil level control acts on a control valve 8 associated to the oil stock tank 3. Oil is then drained from the second compartment 1b of the separation vessel 1, lowering the oil level to reach a value within the control band.

In order to calculate the correction factor, the water and oil flow rates have to be suitably measured in a “reference measuring line”. The resulting measured flow rates are then “reference flow rates” for the MPFM calibration.

The main equipment in each of the two reference measuring lines comprises pumps 10, 12 and flowmeters 11, 13. For both lines, the corresponding flow rate signals measured by the flowmeters will act on the corresponding pumps in order to reach a preset flow rate value set by the field man.

Both the interface position and the oil level controls are independent of the reference measuring lines, i.e. neither control has an action on any of the instrumentation in the water reference measuring line or in the oil reference measuring line.

Even though the description for each of these two types of control were presented separately, it should be noted that during the normal operation of the calibration device and method of the present invention both controls take place simultaneously, in a complementary way.

The section downstream from the reference measuring lines will be hereafter referred to as the “multiphase flow section”. In this section, both streams from the water and oil reference measuring lines are mixed, forming a two-phase liquid stream.

This liquid stream will be mixed to a gaseous stream driven with a compressor 14 from a gas tank 15 connected to the separation vessel 1. The gas flow rate can be adjusted by a valve 16 and monitored by means of a measuring bridge 17. The multiphase flow is then formed by mixing these gaseous and liquid streams.

The multiphase section is equipped with a heater 18 in order to adjust the stream temperature to the values required for the calibration procedure. The multiphase stream line should also be equipped with a spool 19 and an auxiliary process connection. The stream is monitored and measured by means of an inline MPFM 20, which is to be calibrated with the values obtained in the upstream reference measuring lines. The stream exiting the MPFM is then recycled to the separation vessel 1.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

1. A device for calibration of a multiphase flow meter comprising
a separation vessel for separating oil, gas and water phases, comprising a first compartment for containing the oil-and-water mixture to be separated, a second compartment for containing the oil phase already separated, and a gas chamber common to both of said compartments,
an oil pipeline comprising feeding means for providing oil to said second compartment from a stock oil tank, a water pipeline comprising feeding means for providing water to said first compartment from a stock water tank,
a gas pipeline comprising feeding means for providing gas from a stock gas tank,
an oil pipeline comprising outlet means for producing an oil stream out of said separation vessel and setting and metering means for metering said oil stream flow rate,
a water pipeline comprising outlet means for producing a water stream out of said separation vessel and setting and metering means for metering said water stream flow rate,
a gas pipeline comprising outlet means for producing a gas stream out of said separation vessel and setting and metering means for metering said gas stream flow rate,
a collecting pipeline for collecting said oil, gas and water streams into one oil, gas and water stream and feeding means for feeding back the oil, gas and water stream into the separation vessel,
a multiphase flow meter to be calibrated connected to said oil, gas and water stream, producing flow rate measurement data,
a calibrating system for processing measurement data from the oil stream, the gas stream and the water stream, and the oil, gas and water stream flow meters and obtaining a corresponding correction factor for the multiphase flow meter to be calibrated;
the separation vessel further comprising control means for controlling the oil-water interface level in said first compartment within a predetermined range and control means for controlling the oil level in said second compartment within a predetermined range.

2. The device according to claim 1, wherein according to process requirements, the water stock tank may further comprise a separate brine stock tank and all necessary ancillary equipment therefor.

3. A method for calibrating a multiphase flow meter, said method comprising
separating an oil phase, a gas phase and a water phase from a three-phase mixture consisting of a two-liquid oil-and-water phase and a gas phase, in a separation vessel comprising a first compartment for the three-phase mixture and a second compartment for the separated oil and gas phases, producing a water stream from the first compartment, and an oil stream and a gas stream from the second compartment,
setting, measuring and keeping the oil stream flow rate at a predetermined value,
setting, measuring and keeping the water stream flow rate at a predetermined value,
setting, measuring and keeping the gas stream flow rate, at a predetermined value,
combining the oil stream with the water stream in a two-phase oil-and-water stream,
combining the two-phase oil-and-water stream with the gas stream in one three-phase stream containing oil, gas and water,
measuring said three-phase stream flow rate by means of a multiphase flow meter to be calibrated, recycling the three-phase stream to the first compartment of the separation vessel,
processing the obtained three-phase stream flow rate data along with the predetermined oil stream, gas stream and water stream values so as to produce a correction factor,
the method further comprising controlling and keeping the two-liquid oil-and-water phase level in the first vessel compartment within a predetermined range by addition or draining of water from or to a water stock tank, and controlling and keeping the oil phase in the second vessel compartment within a predetermined range by addition or draining of oil from or to an oil stock tank.

4. The method according to claim 3, wherein the control of the two-liquid oil-and-water phase level in the first vessel compartment is made by controlling the oil-water interface position by means of a sensor probe control means and a transmitter.

5. The method according to claim 4, wherein the oil-water interface position control means comprises an Agar Solutions® ID-200 Series Interface Concentration Detector System.

6. The method according to claim 3, wherein the control of the oil phase level in the second vessel compartment is made by means of a level controller selected from the group comprising a radar level transmitter, a guided wave radar level transmitter and an ultrasonic level transmitter.
